(19) United States
(12) Patent Application Publication
(10) Pub. No.: US 2024/0142262 A1
(43) Pub. Date: May 2, 2024

(54) OPERATION MANAGEMENT SYSTEM

(71) Applicants: Toyota Jidosha Kabushiki Kaisha, Toyotta-shi (JP); Komatsu Ltd., Tokyo (JP)

(72) Inventors: Yusuke NOZAWA, Susuno-shi (JP); Shun Mizoo, Zama-shi (JP); Toru Takashima, Susono-shi (JP); Takahiro Okano, Chiryu-shi (JP); Kenta Osagawa, Tokyo (JP); Takashi Hiranaka, Tokyo (JP); Shota Konishi, Tokyo (JP)

(73) Assignees: Toyota Jidosha Kabushiki Kaisha, Toyota-shi (JP); Komatsu Ltd., Tokyo (JP)

(21) Appl. No.: 18/495,164

(22) Filed: Oct. 26, 2023

(30) Foreign Application Priority Data
Nov. 2, 2022 (JP) 2022-176576

(51) Int. Cl. G01C 21/00

(52) U.S. Cl. CPC G01C 21/3819; G01C 21/3841

(57) ABSTRACT

An operation management system including a controller configured to execute: a position obtaining process to obtain positional information from each registered mobility; a correlating process to correlate each registered mobility and specification information stored in a storage device with each other; a travel-history storing process to store, in the storage device, a traveled route which is a travel history of each registered mobility, so as to be correlated with map information; and a road-surface-condition obtaining process to calculate a road surface condition including a position and a shape of a rut corresponding to the traveled route based on information on a detection value of a sensor of each of registered mobility, the type of a road surface included in the map information, the specification information, and the traveled route and to store, in the storage device, the road surface condition so as to be correlated with the map information.

### REFERENCE TO RELATED APPLICATIONS

This application claims priority from Japanese Patent Application No. 2022-176576 filed on Nov. 2, 2022. The entire content of the priority application is incorporated herein by reference.

### BACKGROUND ART

The following disclosure relates to an operation management system.

A system has been developed in which road surface information is stored in a server to create a road surface information map. For instance, Japanese Patent Application Publication No. 2022-069218 describes a road surface information producing apparatus in which a detection value detected by a road-surface-relating-information sensor installed on a vehicle is stored in a storage device to create the road surface information map.

The apparatus described above, however, does not calculate a position and a shape of a rut on a road surface. Thus, the apparatus cannot modify a target route even if the target route includes a road surface on which is formed a rut that is difficult for the vehicle to drive over. When the vehicle travels on a road surface at which tires of the vehicle vibrate at a high vibration frequency, there may be a possibility that the detection value of the sensor installed on the vehicle does not follow the road surface condition. It is thus required for the system to obtain the position and the shape of the rut (such as a height and a width of a protrusion of the rut) for setting an appropriate target route that takes the road surface condition into consideration.

### SUMMARY

Accordingly, an aspect of the present disclosure relates to an operation management system capable of calculating a road surface condition including a position and a shape of a rut.

In one aspect of the present disclosure, an operation management system configured to be capable of communicating with a plurality of registered mobilities to manage operations of the plurality of registered mobilities, each of which is configured to be capable of obtaining positional information thereof, includes: a storage device that stores specification information including information on a position of a tire of each of the registered mobilities and map information including information on a type of a road surface; and a controller including one or more processors. The controller is configured to execute: a position obtaining process in which the controller obtains the positional information from each of the registered mobilities; a correlating process in which the controller correlates each of the registered mobilities that transmits the positional information and the specification information stored in the storage device with each other; a travel-history storing process in which the controller stores, in the storage device, a traveled route which is a travel history of each of the registered mobilities, so as to be correlated with the map information based on the positional information; and a road-surface-condition obtaining process in which the controller i) calculates a road surface condition including a position and a shape of a rut that corresponds to the traveled route based on information on a detection value of a sensor installed on each of the registered mobilities, the type of the road surface included in the map information, the specification information, and the traveled route and ii) stores, in the storage device, the road surface condition so as to be correlated with the map information.

In the operation management system according to the present disclosure, the position and the shape of the rut is calculated based on the traveled route, etc., of the registered mobility, and the result of the calculation is stored as the road surface condition so as to be correlated with the map information. The position of the rut can be calculated based on the traveled route and the position of the tire, for instance. The shape of the rut can be calculated based on the type of the road surface, the specification information (such as the mass of the registered mobility), the traveled route of the registered mobility, and the information on the sensor detection value (such as the traveling speed), for instance. The operation management system according to the present disclosure enables calculation of the road surface condition including the position and the shape of the rut.

### BRIEF DESCRIPTION OF THE DRAWINGS

The objects, features, advantages, and technical and industrial significance of the present disclosure will be better understood by reading the following detailed description of an embodiment, when considered in connection with the accompanying drawings, in which:

FIG. 1 is a view illustrating a configuration of an operation management system according to one embodiment of the present disclosure;

FIG. 2 is a flow chart representing processing executed in the operation management system;

FIG. 3 is a conceptual view for explaining a road-surface-condition obtaining process in the embodiment;

FIG. 4 is another conceptual view for explaining the road-surface-condition obtaining process in the embodiment, the view being a cross-sectional view taken along line IV-IV in FIG. 3;

FIG. 5 is a conceptual view for explaining a target route calculating process in the embodiment;

FIG. 6 is a reference view illustrating a two-degree-of-freedom vibration model; and

FIG. 7 is a flow chart representing one example of processing executed in the operation management system of the embodiment.

### DESCRIPTION

Referring to the drawings, there will be hereinafter described in detail an operation management system 1 according to one embodiment of the present disclosure. It is to be understood that the present disclosure is not limited to the details of the present embodiment but may be embodied with various changes and modifications based on the knowledge of those skilled in the art.

The operation management system 1 according to the present embodiment is configured to be capable of communicating with a plurality of registered mobilities so as to manage operations of the plurality of mobilities. Each of the plurality of mobilities is configured to be capable of obtaining positional information thereof. The registered mobilities are mobilities registered in advance in the operation management system 1. Each mobility is a movable body that travels on a road surface by means of tires. The registered mobilities in the present embodiment include, for instance, a plurality of light vehicles, e.g., vehicles such as pickup trucks, and a plurality of large-sized dump trucks, e.g., large-sized heavy machines. A storage device 11, which will be later explained, stores information on each of the registered mobilities.

The operation management system 1 manages operations of the plurality of mobilities including mobilities different in kind or type. At least one of a control system and a system in the registered mobility is equipped with the function of the operation management system 1. The operation management system 1 of the present embodiment is part of the control system and is disposed in a facility that has a wireless communication device.

Specifically, the operation management system 1 includes the storage device 11 and a controller 12. The storage device 11 is constituted by at least one memory. The storage device 11 stores specification information including information on positions of tires of each registered mobility and map information including information on a type of a road surface. The storage device 11 is communicably connected to the controller 12 and is disposed inside or outside the controller 12. The specification information includes, for each registered mobility, a kind/type, a mass (weight), a tread, a tire width, and a position of each tire, for instance. The tread is a center-to-center distance of right and left tires of the registered mobility. For instance, the position of each tire may be a relative position of the tire with respect to a reference position of a body of the registered mobility. The map information includes, for instance, the location of paved roads and the location of unpaved roads.

The controller 12 is constituted by an electronic control unit (ECU) or a computer, which includes at least one processor 12a and at least one memory (not illustrated). The memory stores various programs and various kinds of data. The processor reads out a program in the memory and executes the program so as to perform various arithmetic computations and controls. The memory of the controller 12 may function as the storage device 11. That is, the storage device 11 may be disposed in the controller 12. Communication in the mobility is performed through a CAN (car area network or controllable area network), for instance.

The controller 12 is configured to be communicable with each registered mobility through a wireless device (not illustrated) and a communication network. The controller 12 receives, from each registered mobility, various kinds of information (such as identification information, positional information, and sensor detection information). The controller 12 is configured to set a target route of a target mobility that is any one of the plurality of mobilities for which the target route is to be set. The target mobility that receives the target route from the operation management system 1 performs automated driving based on the target route. The controller 12 can give the target mobility a command as to a traveling condition such as a traveling speed.

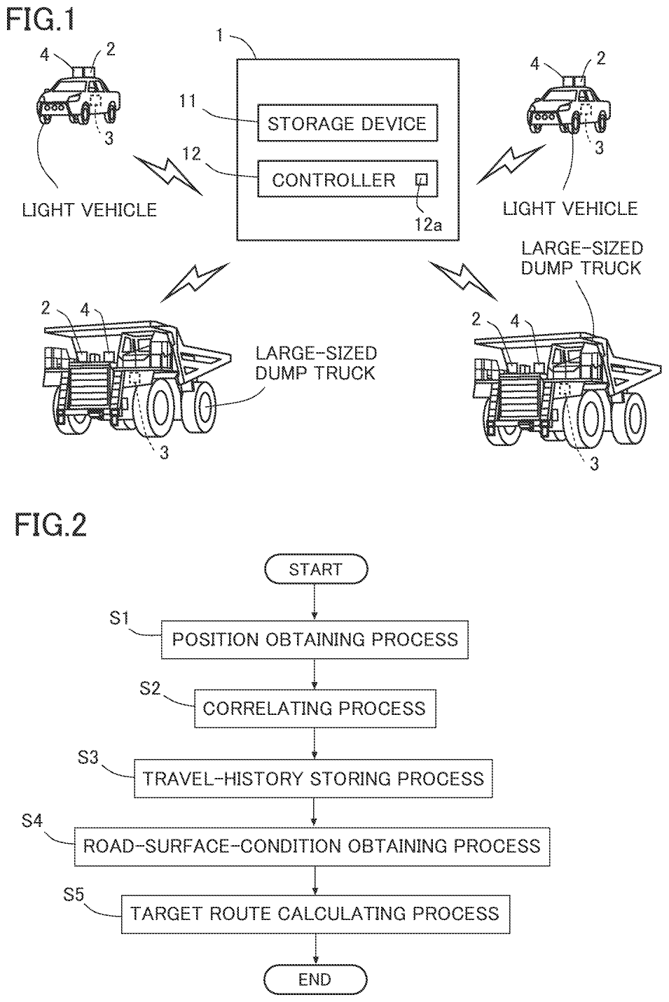

As illustrated in FIG. 1, each registered mobility is equipped with a receiver 2 of the Global Navigation Satellite System (GNSS) and an ECU 3 configured to control traveling of the registered mobility. The registered mobility transmits, to the operation management system 1, the identification information thereof, the positional information thereof based on positioning data of the GNSS calculated by the receiver 2, and the sensor detection information based on detection values of various sensors installed on the registered mobility. Though not illustrated, the sensors installed on each registered mobility include, for instance, wheel speed sensors, a longitudinal acceleration sensor, an up-down (vertical) acceleration sensor, a lateral acceleration sensor, a yaw rate sensor, a pitch rate sensor, a roll rate sensor, and a vehicle height sensor. The traveling speed of the registered mobility can be calculated based on wheel speeds detected by the respective wheel speed sensors, for instance.

As described above, the operation management system 1 receives, from each registered mobility, the identification information, the positional information, and the sensor detection information. The ECU 3 of each registered mobility performs an automated driving control based on the target route and the traveling condition (such as the traveling speed) received from the operation management system 1. Each registered mobility is provided with a wireless device (not illustrated) for communicating with the operation management system 1.

Each of part of or all of the registered mobilities is provided with a surroundings monitoring device 4. The surroundings monitoring device 4 is configured to monitor or recognize surroundings of an own mobility. The surroundings monitoring device 4 includes, for instance, a light detection and ranging or laser imaging detection and ranging (LiDAR) device. The surroundings monitoring device 4 in the present embodiment includes, for instance, one or more LiDAR devices, one or more cameras for taking images of the surroundings of the own mobility, and one or more radar for measuring a distance between the own mobility and an object present in the surroundings of the own mobility. Based on the detection result of the surroundings monitoring device 4 and three-dimensional map data, for instance, the surrounding situation and the own position can be recognized with high accuracy. The ECU 3 is configured to be capable of modifying locally the target route based on the detection result of the surroundings monitoring device 4.

Calculation of Road Surface Condition

The controller 12 calculates a road surface condition based on the information transmitted from each registered mobility. As illustrated in FIG. 2, the controller 12 is configured to execute a position obtaining process S1, a correlating process S2, a travel-history storing process S3, and a road-surface-condition obtaining process S4, so as to calculate the road surface condition. In the position obtaining process S1, the controller 12 obtains, from each registered mobility, the positioning information, which is the GNSS positioning data in the present embodiment.

In the correlating process S2, the controller 12 correlates each mobility that transmits the positional information thereof with the specification information stored in the storage device 11. In the storage device 11, the identification information and the specification information are stored so as to be correlated with each other. Based on the identification information transmitted from the registered mobility, the controller 12 obtains the specification information of the registered mobility stored in the storage device 11. The controller 12 correlates the positional information of the registered mobility and the specification information of the registered mobility based on the identification information and the positional information transmitted therefrom. That is, the controller 12 obtains, in the correlating process S2, the position and the specifications of the registered mobility based on the information transmitted therefrom.

In the travel-history storing process S3, the controller 12 stores, in the storage device 11, a traveled route of each registered mobility so as to be correlated with the map information based on the positional information. The traveled route may be referred to as a travel history. The controller 12 calculates a trajectory traveled by the registered mobility, namely, the traveled route, based on a history of the positional information of the registered mobility, namely, based on time-series positional data. Because the positional information and the map information are correlated with each other, the map information and the traveled route are stored in the storage device 11 so as to be correlated with each other. The controller 12 can indicate the traveled route of each registered mobility on roads of a map displayed on a display. The traveled route corresponding to the time-series positional data enables the controller 12 to grasp at what position and for how long the registered mobility has stayed.

In the road-surface condition obtaining process S4, the controller 12 i) calculates the road surface condition including a position and a shape of a rut that corresponds to the traveled route based on the information on detection values of the sensors installed on each registered mobility, the specification information, and the traveled route and ii) stores, in the storage device 11, the road surface condition so as to be correlated with the map information.

In the road-surface condition obtaining process S4, the controller 12 calculates a position and a shape of a rut for a selected registered mobility that is a selected one of the plurality of registered mobilities. The controller 12 calculates the position and the shape of the rut eventually for all the traveling registered mobilities. The controller 12 calculates the position of the rut based on the traveled route of the selected registered mobility, a tread of the selected registered mobility corresponding to the traveled route, a tire width of the selected registered mobility corresponding to the traveled route, and the information on the type of the road surface included in the map information. The type of the road surface includes, for instance, a paved road and an unpaved road. The type of the road surface may be set in more details. For instance, there may be set, as a classification item, a type of the unpaved road such as soil or rock.

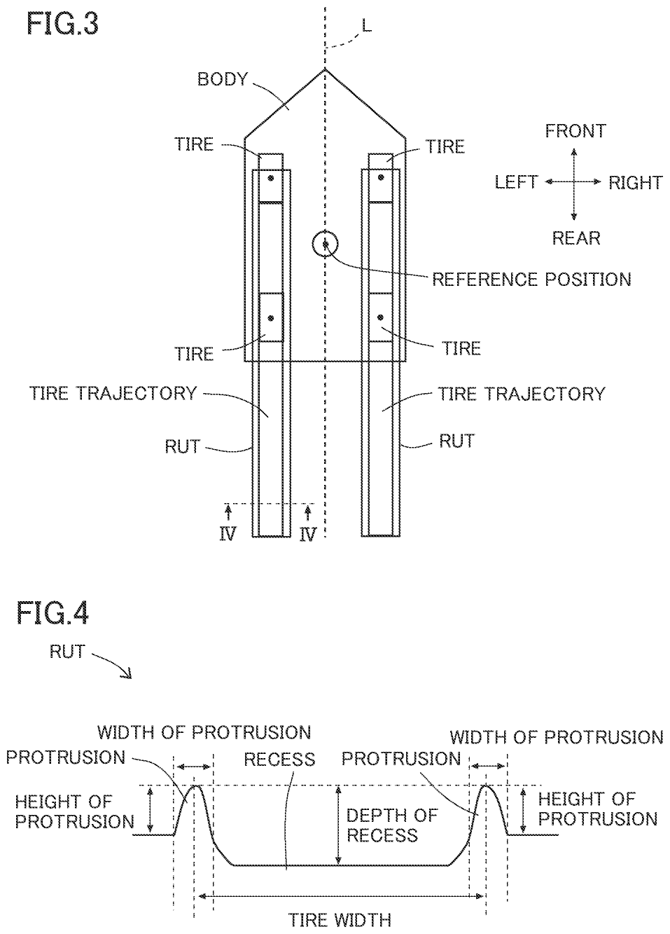

In the controller 12, a reference position is set as a position corresponding to the positional information (the positioning data) of the registered mobility. The reference position is set at a center position of the registered mobility, for instance. As illustrated in FIG. 3, the controller 12 assumes that the reference position (the center position) of the registered mobility is located on a traveled route L indicated by a line on the map and calculates a track or a trajectory of each tire (that may be referred to as a history of a tire position on the road surface) based on the tire width and a relative position of the center of the tire with respect to the center position of the registered mobility. Each tire track (tire trajectory) is formed along the traveled route L.

The reference position of the registered mobility corresponding to the positional information is not limited to the center position described above but may be set optionally in accordance with the installation position of the receiver 2, for instance. In a case where the reference position corresponding to the positional information (the positioning data) is set for each of the registered mobilities, the controller 12 sets the relative position of each tire center with respect to the traveled route L for each of the registered mobilities to calculate the tire trajectory. The position of the rut corresponds to the tire trajectory. The rut is formed along the tire trajectory. The controller 12 may be configured to calculate the position of the rut when the weather is rainy and the traveling path of the registered mobility is an unpaved road, for instance. That is, the controller 12 may refer to weather information in calculating the road surface condition.

In a case where the type of the road surface corresponding to the traveled route is a paved road, the controller 12 in the present embodiment determines that the rut is not formed on the road surface and does not calculate the position of the rut. That is, the road surface condition of the paved road is not updated in this case. In the present embodiment, the susceptibility of the road surface to deformation is set to 0 in a case where the type of the road surface is the paved road. Hereinafter, the calculation of the road surface will be explained referring to a case where the type of the road surface is the unpaved road.

In a case where the type of the road surface corresponding to the traveled route is the unpaved road, the controller 12 determines that the rut is formed on the road surface along the tire trajectory. As illustrated in FIG. 4, the rut is set in the present embodiment such that the rut is constituted by two protrusions and a recess formed between the two protrusions. The controller 12 considers or assumes that the protrusions are formed respectively on the right side and the left side of each tire and the recess is formed under the ground contact area of each tire. When the type of the road surface is the unpaved road, the position of the rut is set for the map information by the controller 12, namely, the position of the rut is set on the map by the controller 12, such that the position of the rut follows the tire trajectory.

The controller 12 calculates the shape of the rut based on, for instance, the traveled route of the registered mobility, a mass of the registered mobility, a turning radius upon turning of the registered mobility, a traveling speed of the registered mobility, lateral acceleration of the registered mobility, and the type of the road surface. The turning radius is calculated based on the traveled route, for instance. The information on the traveling speed and the lateral acceleration can be obtained based on detection values of wheel speed sensors and an acceleration sensor installed on the registered mobility. The controller 12 calculates the susceptibility of the road surface to deformation when calculating the shape of the rut (here, the height and the width of each protrusion and the depth of the recess).

The susceptibility of the road surface to deformation is set based on the type of the road surface and the information on weather (such as weather conditions and humidity). The controller 12 in the present embodiment obtains the weather information when the registered mobility has traveled on the road surface from web sites on the Internet via the communication network, for instance. The controller 12 utilizes the weather information in the calculation of the road surface condition. For instance, the unpaved road when the weather is rainy is more susceptible to road surface deformation than the unpaved road when the weather is sunny.

The susceptibility of the road surface to deformation may be set by numerical values or may be set by a level divided into a plurality of steps. In a case where the road is an unpaved road whose surface is soil and the weather is rainy, the susceptibility of the road surface to deformation is a maximum level. On the other hand, in a case where the road is an unpaved road whose surface is rocky and the weather is sunny, the susceptibility of the road surface to deformation is a minimum level among unpaved roads. When the type of the unpaved road includes a distinction between soil and rock, the unpaved road whose surface is soil is more susceptible to road surface deformation than the unpaved road whose surface is rocky. The road surface deformation is likely to occur when the weather is rainy than when the weather is sunny. Further, the road surface deformation is likely to occur when the humidity is higher. The higher the susceptibility of the road surface to deformation, the greater the height and the width of the protrusions of the rut and the depth of the recess of the rut.

The controller 12 calculates, as the shape of the rut, mainly the height and the width of each protrusion and the depth of the recess. The geometry of inclined surfaces, etc., of the protrusion is determined utilizing a geometric model set in advance in accordance with the height and the width of the protrusion. One example of settings in the calculation of the shape of the rut in the present embodiment is as follows. The greater the mass of the registered mobility, the greater the height and the width of the protrusion and the depth of the recess. The longer the length of time of stay of the registered mobility, namely, the lower the traveling speed of the registered mobility, the greater the height and the width of the protrusion and the depth of the recess. The length of time of stay is inversely proportional to the traveling speed.

The greater the shift of the load in the right-left direction upon turning or cornering of the registered mobility, the greater the height and the width of the protrusion on the outer side of a turning path, for instance. The controller 12 calculates the magnitude of the shift of the load in the right-left direction based on the traveling speed, the turning radius (or the turning curvature), and a roll moment. The roll moment is calculated based on, for instance, a difference between the gravitational center height and the roll center height of the registered mobility, a sprung mass of the registered mobility, and lateral acceleration upon turning. In calculating the roll moment, the controller 12 grasps the lateral acceleration upon turning based on information on the detection value of the lateral acceleration sensor installed on the registered mobility and obtains other information based on the specification information.

As described above, the controller 12 calculates the shape of the rut mainly based on the susceptibility of the road surface to deformation, the mass of the registered mobility, the shift of the load in the right-left direction due to roll, and the length of time of stay of the registered mobility, i.e., the traveling speed of the registered mobility. Owing to the calculation of the position and the shape of the rut, the controller 12 can set a target route along which the target mobility is capable of traveling or a target route that enables obtainment of the sensor detection values that follow the road surface condition. The target mobility is any one of the plurality of registered mobilities for which the target route is to be set.

Setting Target Route

The controller 12 is configured to execute a target route calculating process S5 in which the controller 12 calculates the target route along which the target mobility is capable of traveling based on the positional information of the target mobility, the destination of the target mobility, and the road surface condition stored in the storage device 11 (FIG. 2). The controller 12 calculates the target route of the target mobility based on the current location of the target mobility based on the positional information, the destination of the target mobility set by a user or the like, and the position and the shape of the rut correlated with the map information. The controller 12 grasps the position and the shape of the rut from the road surface condition and sets the target route avoiding the rut that makes it difficult for the target mobility to travel.

For instance, the controller 12 calculates a tentative target route based on the current location and the destination of the target mobility. The controller 12 refers to the road surface condition and determines whether there exists, on the tentative target route, a large rut that the target mobility cannot get over. (Such a rut will be hereinafter simply referred to as a “large rut”.) If the large rut exists on the tentative target route, the controller 12 modifies the tentative target route so as to avoid the large rut and sets the modified tentative target route to the target route. If no large rut exists on the tentative target route, the controller 12 sets the tentative target route to the target route. The roadability of each registered mobility is stored in the storage device 11 as the specification information.

For instance, the storage device 11 may include, for each registered mobility, an upper limit value of the height of the protrusion of the rut that the registered mobility can get over. The registered mobility may easily get over the rut by traveling at right angles relative to the direction of extension of the rut. Thus, the storage device 11 may include the upper limit value of the height of the protrusion that the registered mobility can get over when the angle of entry of the registered mobility into the rut is the right angle. The controller 12 can set the target route also in consideration of the angle of entry into the rut.

If the rut exists on the tentative target route, the controller 12 sets a target route that causes the target mobility to enter the rut at an angle for enabling the target mobility to get over the rut or the controller 12 sets a target route that avoids the rut. The storage device 11 may store, for each kind or type of the registered mobility, a relationship between the angle of entry into the rut and the upper limit value of the height of the protrusion of the rut that the registered mobility can get over.

Setting Target Route in Consideration of Road Surface Frequency

In addition to the condition of calculating the route along which the target mobility can travel, the controller 12 may calculate the target route further in consideration of a road surface frequency. The road surface frequency is calculated based on unevenness of the road surface and the traveling speed of the mobility that travels on the road surface. Here, the unevenness of the road surface is regarded as a waveform, and it is assumed that a material point moves along the waveform. In this instance, the frequency at which the material point vibrates upward and downward, namely, the road surface frequency, is determined by a speed at which the material point moves on the waveform. The higher the road surface frequency, the higher the vibration frequency of the material point that moves along the road surface.

When the condition of the road surface on which the mobility travels is bad and the unsprung portion of the mobility vibrates at a high frequency, for instance, there is a possibility that the vibration of the unsprung portion does not follow the road surface condition. If the vibration of the unsprung portion does not follow the road surface condition, the detection values of the sensors installed on the unsprung portion and the road surface condition do not correspond to each other. When the road surface frequency is higher than the natural frequency of the unsprung portion of the mobility, for instance, the movement of the unsprung portion does not follow the unevenness of the road surface. That is, the detection values of the sensors installed on the unsprung portion of the mobility do not correspond to the road surface condition. During traveling of the mobility, the change in the road surface unevenness viewed from the mobility, the movement of the unsprung portion, and the movement of the sprung portion are mutually independent elements. Accordingly, there is a possibility that the road surface frequency does not match the movement of the unsprung portion or the sprung portion at a position thereof where the sensor is installed.

The sprung portion refers to a portion of the mobility that includes the body of the mobility and that is supported by suspension devices. The sprung portion may refer to a portion of the mobility that includes the body (vehicle body) and that is located nearer to the body than suspension springs. The sprung portion corresponds to a portion indicated by “m2” in FIG. 6. The unsprung portion refers to a portion of the mobility that is located lower than coil springs of the suspension devices. The unsprung portion means undercarriage components. The unsprung portion may refer to a portion of the mobility that includes the wheels and the wheel support members and that is located nearer to the wheels than the suspension springs. The unsprung portion includes undercarriage components such as a wheel, a tire, a brake, a suspension arm, a drive shaft, and a stabilizer.

In the present embodiment, the natural frequency of the unsprung portion is the natural frequency of the undercarriage components as a whole. For instance, the mass of the undercarriage components as a whole is utilized in calculating the natural frequency of the unsprung portion. The natural frequency of the unsprung portion is higher than that of the sprung portion. The natural frequency of the sprung portion (e.g., 1-2 Hz) is considerably lower than the natural frequency of the unsprung portion (e.g., 11-13 Hz). It is thus considered that the natural frequency of the sprung portion may be ignored when considering the vibration of the unsprung portion.

When the road surface frequency is higher than the natural frequency of the unsprung portion, the movement of the unsprung portion in the up-down direction does not correspond to the unevenness of the road surface. In this case, the detection value of the sensor installed on the unsprung portion represents a condition different from the actual road surface condition. This results in a decrease in the reliability of the sensor detection value in the calculation of the road surface condition. In view of this, the controller 12 in the present embodiment calculates, in the target route calculating process S5, the target route such that the road surface frequency is not higher than a predetermined threshold frequency for enabling the detection value of the sensor installed on the target mobility to match the actual road surface condition.

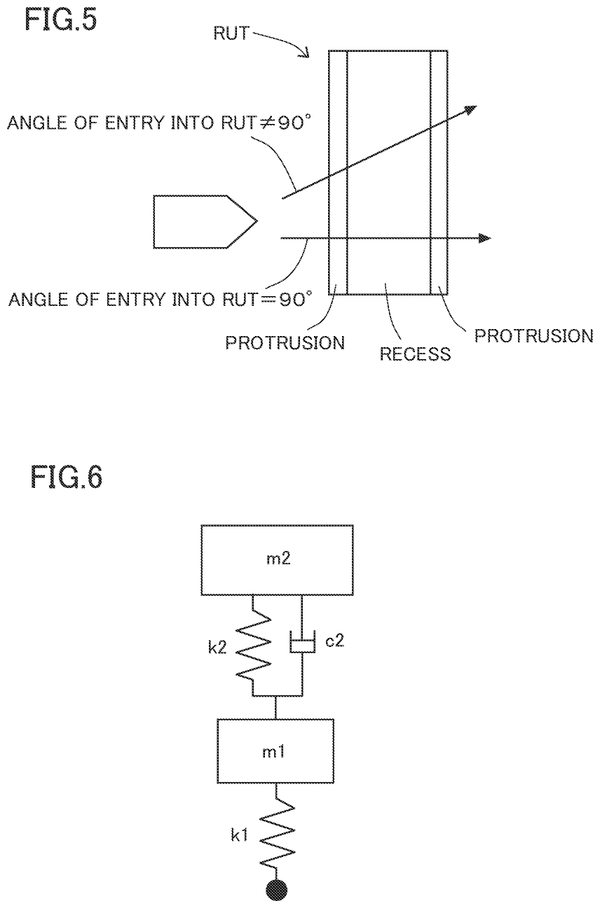

The road surface frequency is calculated based on a width of the unevenness of the road surface and a traveling speed of the target mobility when traveling on the uneven road surface. The width of the unevenness of the road surface is calculated based on the width of the protrusion of the rut and the angle of entry of the target mobility into the rut. In a case where an angle formed by the direction of extension of the rut and the traveling direction of the target mobility is 90 degrees (the right angle), namely, in a case where the angle of entry into the rut is 90 degrees, as illustrated in FIG. 5, the width of the unevenness of the road surface is the same as the width of the protrusion stored in the storage device 11. In a case where the angle of entry into the rut is not equal to 90 degrees, the target mobility travels across the protrusion diagonally, and the width of the unevenness of the road surface is accordingly greater than the width of the protrusion stored in the storage device 11. That is, in the case where the angle of entry into the rut is not equal to 90 degrees, the target mobility does not travel across the protrusion at the shortest distance, and the distance by which the target mobility travels over the protrusion, namely, the width of the unevenness of the road surface, is increased. By dividing the width of the unevenness of the road surface by the traveling speed, the cycle of the road surface is calculated. The inverse of the cycle of the road surface is the road surface frequency.

In setting the target route, the controller 12 can adjust the width of the unevenness of the road surface by adjusting the angle of entry into the rut. The controller 12 can adjust the road surface frequency by adjusting the angle of entry into the rut and the traveling speed when the registered mobility travels across the rut. The controller 12 sets the target route and the traveling condition (such as the traveling speed) such that the road surface frequency is not higher than the threshold frequency.

In the present embodiment, the threshold frequency is set based on the natural frequency relating to the components of the target mobility. Specifically, the threshold frequency is set based on the natural frequency of a component that affects a portion of the target mobility where there is disposed a sensor, for which it is desired to obtain the detection value that represents the actual road surface condition. In the present embodiment, the threshold frequency is set to the natural frequency of the unsprung portion of the target mobility. When the road surface frequency is lower than the natural frequency of the unsprung portion, the detection value of the sensor installed on the unsprung portion follows the unevenness of the road surface. The detection value of the sensor installed on the sprung portion can be corrected based on the detection value of the sensor of the unsprung portion that follows the road surface condition. The movement of the sprung portion can be calculated based on the movement of the unsprung portion and a two-degree-of-freedom vibration model illustrated in FIG. 6. That is, in a case where the detection value of the sensor of the unsprung portion follows the unevenness of the road surface, the accuracy of correction of the detection value of the sensor of the sprung portion is high. If the movement of the unsprung portion reflects the road surface condition, it is possible to correct, by calculation, the detection value of the sensor installed on the mobility so as to represent the road surface condition. It is thus desirable to set the threshold frequency to a value lower than or equal to the natural frequency of the unsprung portion of the target mobility.

The vibration of the registered mobility in the up-down direction can be considered utilizing the two-degree-of-freedom vibration model of FIG. 6 as a reference. In FIG. 6, “m2” represents a sprung mass, “m1” represents an unsprung mass, “k2” represents a spring constant corresponding to a suspension device, “k1” represents a spring constant corresponding to a tire, and “c2” represents a damper coefficient corresponding to a shock absorber of the suspension device. The motion in the up-down direction of the sprung portion corresponding to m2 and the motion in the up-down direction of the unsprung portion corresponding to m1 can be each calculated according to a known equation of motion.

The natural frequency of the unsprung portion can be calculated based on, for instance, the mass m1 of the components of the unsprung portion as a whole and the spring constant k1. The natural frequency of the unsprung portion can be measured using a device for applying a vibration to the mobility from below, namely, a device for applying a vibration to the ground contact area of the tire. The natural frequency of the unsprung portion of the vehicle is about 11-13 Hz, for instance. In a case where it is estimated that the natural frequency of the unsprung portion of the target mobility falls within a range from about 11 Hz to 13 Hz, the threshold frequency is set to a value lower than or equal to 11 Hz that is a minimum value in the range. The threshold frequency may be set so as to be the same value for all the registered mobilities or may be set for each of the registered mobilities. The threshold frequency is stored in the storage device 11, for instance. The controller 12 sets the target route based on the road surface frequency and the threshold frequency, thus enabling the detection values of the sensors installed on the target mobility to follow the road surface condition. With this configuration, the operation management system 1 can obtain the road surface condition with high accuracy. The controller 12 can calculate, as the road surface condition, the unevenness of the road surface based on not only the rut but also the detection value of the acceleration sensor or the like.

By setting all the registered mobilities to the target mobilities and setting the target route of each target mobility such that the road surface frequency is not higher than the threshold frequency, the behaviors of all the registered mobilities that are under control of the control system follow the unevenness of the road surface. This enables the road surface information to be generated with high accuracy based on the detection values of the sensors installed on each registered mobility. Each sensor installed on the registered mobility may be referred to as a behavior detection sensor for detecting the behavior of the registered mobility or a road-surface-information detection sensor for detecting the road surface information. In a case where the registered mobility is equipped with an external sensor such a stereo camera, it is possible to correct images of the external sensor based on the detection values of the sensors installed on the registered mobility. If an input from the road surface is available, it is possible to calculate how the input is transmitted to the sensors of the unsprung portion and the sensors of the sprung portion. Based on the detection value of one sensor corresponding to the road surface, the controller 12 can correct the detection value of the one sensor, correct the detection values of the sensors installed on the unsprung portion, and correct the detection values of the sensors installed on the sprung portion.

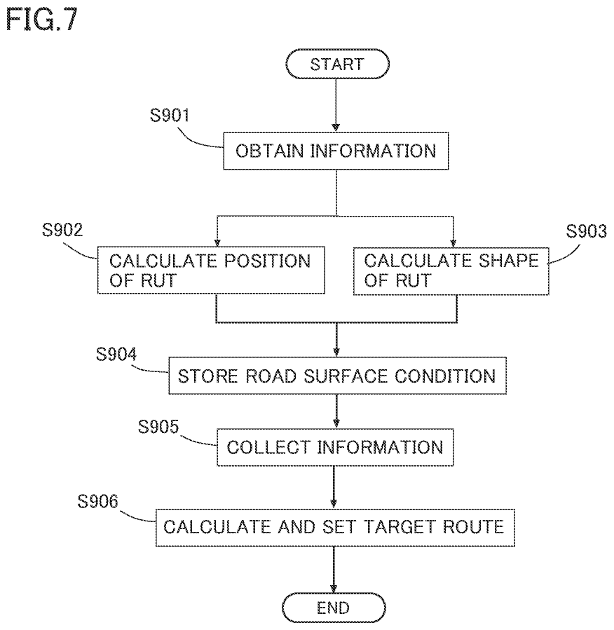

Referring to a flow chart of FIG. 7, there will be described one example of processing executed by the operation management system 1. As illustrated in FIG. 7, the controller 12 obtains the information from each registered mobility (S901). The controller 12 calculates the position and the shape of the rut based on the obtained information (S902, S903). Specifically, the controller 12 calculates the position of the rut based on the traveled route, the type of the road surface included in the map information, and the tire positions included in the specification information (S902). The controller 12 may calculate the position of the rut further based on the weather information. The controller 12 calculates the shape of the rut based on the lateral acceleration and the traveling speed, each of which is the information relating to the detection values of the sensors, the type of the road surface, the traveled route, the weather information, and the mass of the registered mobility included in the specification information (S903).

The controller 12 stores, in the storage device 11, the information on the road surface condition including the position and the shape of the rut so as to be correlated with the map information (S904). The controller 12 updates the information on the road surface condition based on the traveled routes of all the registered mobilities, correlate the information on the road surface condition with the map information, and collect the information on the road surface condition in the storage device 11 (S905). The controller 12 calculates the target route based on the collected information on the road surface condition (S906). In a case where the unpaved road is leveled, the information on the road surface condition corresponding to the leveled area is reset.

As described above, the operation management system 1 according to the present embodiment calculates (estimates) the road surface condition including the position and the shape of the rut and sets the target route that takes the road surface condition into consideration. In a situation such as a mine where large-sized heavy machines and light vehicles travel, the rut formed by traveling of the large-sized heavy machines often has a size that makes it difficult for the light vehicles to drive over. Even in such a situation, the operation management system 1 can set the target route that avoids only the large rut that the target mobility cannot get over. Further, the registered mobility travels along the target route that is set such that the road surface frequency is not higher than the threshold frequency, so that the controller 12 can obtain the information on the road surface condition with high accuracy.

Modifications

It is to be understood that the present disclosure is not limited to the embodiment illustrated above. For instance, part of the processing of the operation management system 1 may be executed by the control system, and the rest of the processing may be executed by the ECU 3 of the registered mobility. That is, the controller 12 may be constituted by two or more ECUs or two or more computers that are physically spaced apart from each other. The control system may execute the position obtaining process S1 through the road-surface-condition obtaining process S4, and the ECU 3 of the registered mobility may execute the target route calculating process S5. The ECU 3 can obtain the information on the road surface condition from the control system. The operation management system 1 may be constituted only by the ECU or the computer installed on the registered mobility.

The calculation condition for calculating the shape of the rut may be set such that the smaller the turning radius, the greater the height of the protrusion of the rut located on the outer side of the turning path of the registered mobility. The calculation condition may be set such that the higher the traveling speed, the greater the height and the width of the protrusion on the outer side of the turning path of the registered mobility. Irrespective of the natural frequency of the unsprung portion, the threshold frequency may be set based on the natural frequency at the location where the sensor is disposed, such that the detection value of the intended sensor follows the road surface condition. The threshold frequency may be set to the natural frequency of the sprung portion, for instance. In the calculation of the shape of the rut, the presence or absence of sudden braking may be taken into consideration. In the calculation of the road surface frequency, the distance between the two protrusions of the rut, i.e., the width of the recess, may be taken into consideration. In the present disclosure, “correlating” may be rephrased as “associating”. It can be said that the operation management system of the present disclosure includes a position obtaining portion that executes the position obtaining process S1, a correlating portion that executes the correlating process S2, a travel-history storing portion that executes the travel-history storing process S3, a road-surface-condition obtaining portion that executes the road-surface-condition obtaining process S4, and a target route calculating portion that executes the target route calculating process S5. The specification information used in the calculation of the road surface condition may include the tire size, the tire tread pattern, etc. The natural frequency is also referred to as a resonance frequency.

What is claimed is:

1. An operation management system configured to be capable of communicating with a plurality of registered mobilities to manage operations of the plurality of registered mobilities, each of which is configured to be capable of obtaining positional information thereof, the operation management system comprising:
a storage device that stores specification information including information on a position of a tire of each of the registered mobilities and map information including information on a type of a road surface; and
a controller including one or more processors,
wherein the controller is configured to execute:
a position obtaining process in which the controller obtains the positional information from each of the registered mobilities;
a correlating process in which the controller correlates each of the registered mobilities that transmits the positional information and the specification information stored in the storage device with each other;
a travel-history storing process in which the controller stores, in the storage device, a traveled route which is a travel history of each of the registered mobilities, so as to be correlated with the map information based on the positional information; and
a road-surface-condition obtaining process in which the controller i) calculates a road surface condition including a position and a shape of a rut that corresponds to the traveled route based on information on a detection value of a sensor installed on each of the registered mobilities, the type of the road surface included in the map information, the specification information, and the traveled route and ii) stores, in the storage device, the road surface condition so as to be correlated with the map information.

2. The operation management system according to claim 1,
wherein the controller calculates, in the road-surface-condition obtaining process, the position and the shape of the rut for a selected registered mobility that is a selected one of the plurality of registered mobilities,
wherein the controller calculates the position of the rut based on: the traveled route of the selected mobility; the type of the road surface included in the map information; and the position of the tire of the selected registered mobility included in the specification information, and
wherein the controller calculates the shape of the rut based on: lateral acceleration and a traveling speed of the selected registered mobility, each of which is the information on the detection value of the sensor installed on the selected registered mobility; the type of the road surface; the traveled route of the selected registered mobility; and a mass of the selected registered mobility included in the specification information.

3. The operation management system according to claim 1, wherein, in the road-surface-condition obtaining process, the controller calculates the road surface condition further based on weather information.

4. The operation management system according to claim 1, wherein the controller is configured to execute a target route calculating process in which the controller calculates a target route, along which a target mobility is capable of traveling, based on the positional information of the target mobility, a destination of the target mobility, and the road surface condition stored in the storage device, the target mobility being any one of the plurality of registered mobilities for which the target route is to be set.

5. The operation management system according to claim 4, wherein, in the target route calculating process, the controller calculates the target route and a traveling condition of the target mobility such that a road surface frequency is not higher than a predetermined threshold frequency, the road surface frequency being calculated based on unevenness of a road surface and a traveling speed of the target mobility that travels on the road surface.

6. The operation management system according to claim 5, wherein the threshold frequency is set to a value not higher than a natural frequency of an unsprung portion of the target mobility.
